(19) United States
(12) Patent Application Publication
(10) Pub. No.: US 2008/0059923 A1
(43) Pub. Date: Mar. 6, 2008

(54) LSI POWER CONSUMPTION CALCULATION METHOD AND CALCULATION PROGRAM

(75) Inventors: Takayuki Sasaki, Kawasaki (JP); Junichi Niitsuma, Kawasaki (JP); Kazuhide Tamaki, Kawasaki (JP); Ryuji Fujita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/849,999

(22) Filed: Sep. 4, 2007

(30) Foreign Application Priority Data
Sep. 4, 2006 (JP) 2006-239335

(51) Int. Cl. G06F 17/50

(52) U.S. Cl. 716/4

(57) ABSTRACT

A logic simulation is executed for a first netlist, activity rate data is determined for the gated clock buffer, the power consumption is calculated from the activity rate data. Thereafter, given a modified second netlist having at least a portion of the cells of the first netlist, activity rate data for the second netlist is determined from activity rate data for the first netlist, based on the correspondence relation between the gated clock buffers for the first and second netlists. The power consumption is calculated from the activity rate data thus determined. By this means, the power consumption can be estimated for the second netlist without again performing a logic simulation.

### CROSS-REFERENCE TO RELATED APPLICATIONS

This application is based upon and claims the benefit of priority from the prior Japanese Patent Application No. 2006-239335, filed on Sep. 4, 2006, the entire contents of which are incorporated herein by reference.

### BACKGROUND

1. Field

The embodiment relates to a LSI power consumption calculation method and calculation program, and in particular relates to a method and program which, after estimating power consumption for a netlist generated by logic synthesis of design data described in a hardware description language (HDL), use only a small number of processes to estimate the power consumption of a modified netlist generated from slightly modified design data.

2. Description of the Related Art

LSI design in recent years has employed a method in which design data described in a HDL is employed in logic synthesis to generate a netlist which defines connections of a plurality of cells within an LSI, and from this netlist, layout data is generated by layout tools via logical verification. In this case, power consumption in the LSI is estimated at the time the netlist is generated. Power consumption includes dynamic power consumption which occurs depending on circuit operation, and static power consumption such as leak currents which occurs regardless of circuit operation; dynamic power consumption accounts for the greater portion of all power consumption. Among dynamic power consumption, power consumption in clock wiring is greater than power consumption in data paths, and in particular, power consumption is large in clock tree wiring and in flip-flop clock portions.

The dynamic power consumption Pd in data lines and clock lines can be calculated using Pd=CV²fα, where C is the wiring capacitance, V the applied voltage, f the frequency (clock frequency), and α is the activity rate. Here, the activity rate α is the rate at which data lines and clock lines change between H level and L level, and is calculated from operation waveforms obtained by executing logic simulations with prescribed input patterns applied to the logic circuit of the netlist.

Hence when calculating the dynamic power consumption, a logic simulation is performed of the netlist mapped at the gate level of the ASIC library, and signal waveforms are extracted. These signal waveforms, the netlist, and power consumption data for the library are input to a power analysis tool. The power analysis tool calculates the is activity rates from the signal waveforms, and uses power consumption values registered in the library and the activity rates to calculate power consumption during the simulation interval.

In this way, numerous machine-hours are required to calculate power consumption from a given netlist. Methods of calculation of power consumption are described in Japanese Patent Laid-open No. 2-136755, Japanese Patent Laid-open No. 2-171861, Japanese Patent Laid-open No. 2001-59856, Japanese Patent Laid-open No. 2002-288257, Japanese Patent Laid-open No. 2003-256495, and Japanese Patent Laid-open No. 2004-62238.

As explained above, in calculations of power consumption, a considerable amount of time is required to execute a netlist logic simulation and obtain signal waveform data, leading to increases in design costs. As a separate problem, upon clock tree synthesis and adding buffers for timing adjustment to a first netlist which has been generated, a modified second netlist is generated. Or, after calculating power consumption using the first netlist, slight modifications are made to design data and logic synthesis performed to generate a second netlist, or a different logic synthesis tool is used in logic synthesis to generate a second netlist, or for some other reason, a modified second netlist is generated. In this case, logic simulation must again be executed for the second netlist to calculate power consumption, leading to increases in design costs.

With progress in logic synthesis tools, functions have been developed for automatic insertion of gated clock buffers in order to reduce the amount of labor involved. In this case, a gated clock buffer is appended with an arbitrary name not identified by the designer, and this function also causes the netlist to be frequently modified, so that logic simulations must be executed and power consumption calculated for each of the resulting netlists.

### SUMMARY

The embodiment provided that a LSI power consumption calculation method and calculation program including the calculating power consumption of a second netlist modified based on a first netlist.

### BRIEF DESCRIPTION OF THE DRAWINGS

FIG. 1 explains automatic generation of gated clock buffers in logic synthesis;

FIG. 2 shows an example of HDL design data;

FIG. 3 shows an example of a netlist obtained from logic synthesis of the HDL design data RTL of FIG. 2;

FIG. 4 is a logic circuit diagram for the netlist of FIG. 3;

FIG. 5 is a logic circuit diagram for another netlist;

FIG. 6 explains retiming processing;

FIG. 7 is a flowchart of the method of LSI power consumption calculation in one embodiment;

FIG. 8 shows the configuration of a power consumption calculation device in one embodiment;

FIG. 9 is a flowchart of generation of activity rate data for a netlist NL2;

FIG. 10 is a flowchart of the correspondence table creation processing 200 of FIG. 9;

FIG. 11 is a flowchart of gated clock buffer correspondence table creation;

FIG. 12 is a second flowchart of gated clock buffer correspondence table creation;

FIG. 13 is a flowchart of correspondence table creation processing between netlists;

FIG. 14 is a flowchart of activity rate data creation processing;

FIG. 15 shows activity rate data OR1 for a first netlist NL1;

FIG. 16 shows cell data for a cell library 130;

FIG. 17 shows examples of rename lists RNA1, 2;

FIG. 18 shows a relational netlist for the first netlist NL1;

FIG. 19 shows an example of a gated clock buffer correspondence table;

FIG. 20 is a diagram explaining a search algorithm for a netlist correspondence table;

FIG. 21 is another diagram explaining a search algorithm for a netlist correspondence table;

FIG. 22 shows a netlist correspondence table;

FIG. 23 shows activity rate data OR2 for a netlist NL2;

FIG. 24 is a flowchart of a LSI power consumption calculation method in another embodiment;

FIG. 25 shows generated gated clock buffer tables; and,

FIG. 26 shows a netlist correspondence table.

### DESCRIPTION OF THE EMBODIMENTS

Below, embodiments are explained referring to the drawings. However, the technical scope of the invention is not limited to these embodiments, but extends to the inventions described in the scope of claims and to inventions equivalent thereto.

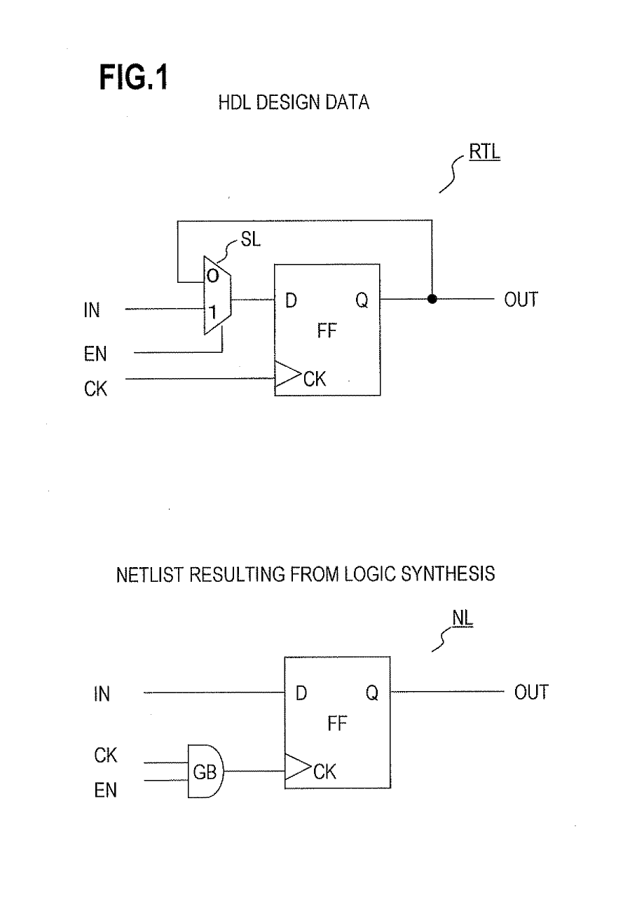

FIG. 1 explains automatic generation of gated clock buffers in logic synthesis. Design data RTL described in HDL describes the logic circuit at the register transfer level (RTL). The design data RTL shown in FIG. 1 is not an actual description example, but describes a logic circuit in which, when the enable signal EN is “1”, an input signal IN is latched by the flip-flop FF which is a register in response to the clock CK, and when the enable signal EN is “0”, no latching is performed. Hence an input signal IN or the output signal Q of the flip-flop FF is input via the selector SL to the data input terminal D of the flip-flop FF, and switching of the selector SL is performed based on the enable signal EN.

When the design data RTL is subjected to logic synthesis using a logic synthesis tool, in general a netlist of a logic circuit, which defines connections of a plurality of cells within an LSI, shown as design data RTL in FIG. 1, is generated.

In order to reduce power consumption, in recent years logic synthesis tools have been provided with functions to automatically insert gated clock buffers which supply a clock signal CK to a register in response to an enable signal EN. That is, as indicated by the netlist NL in FIG. 1, a netlist of the logic circuit is generated in which a gated clock buffer GB is inserted in a stage preceding the clock input terminal of the flip-flop FF, and the clock CK is supplied to the flip-flop FF according to the enable signal EN.

According to the logic circuit for the design data RTL in FIG. 1, the clock CK always changes between H level and L level, and on each clock cycle the flip-flop FF executes an operation to latch the data input D. Hence even when the enable signal EN is at the inactive state (0 level), the flip-flop is operating, and so power consumption is high. On the other hand, according to the logic circuit of a netlist NL in which a gated clock buffer GB is inserted, a clock signal CK is supplied to the flip-flop FF according to the enable signal EN. Hence while the enable signal EN is at the inactive state (0 level), supply of the clock signal CK to the flip-flop FF is halted, and operation of the flip-flop is halted, so that power can be conserved. Thus automatic insertion of gated clock buffers by a logic synthesis tool greatly contributes to power conservation.

Such a gated clock buffer controls flip-flop operation based on enable signals, and so is generally added in the stage preceding the flip-flop, which is one type of cell register.

However, this automatic insertion of a gated clock buffer is performed in a process which cannot be controlled by the designer, and so the designer cannot identify in detail the names of gated clock buffers or positions of their insertion. Moreover, the names of automatically inserted gated clock buffers are different for each logic synthesis tool, and may also differ with the HDL design data.

Hence when design data is slightly modified for debugging or some other purpose, and new design data is generated, the netlist resulting from logic synthesis of the new design data has gated clock buffers which are configured slightly differently from those of the netlist resulting from logic synthesis of the initial design data. Further, even when the design data is the same, there are likewise differences among netlists generated using upgraded versions of logic synthesis tools or using logic synthesis tools from different vendors.

Thus in order to calculate power consumption for a modified netlist, in the prior art there was only the method of performing power calculations from the start for the netlist using a power consumption calculation tool. Thus despite the fact that a large portion of the netlist is the same, numerous machine-hours were required to estimate power consumption, leading to increased costs of LST development. In particular, a vast number of machine-hours were required for logic simulations.

Prior to explaining the method of calculation of LSI power consumption of this embodiment, an example of HDL design data and a netlist is explained. Then, this specific example is used to explain the method of calculating power consumption of this embodiment.

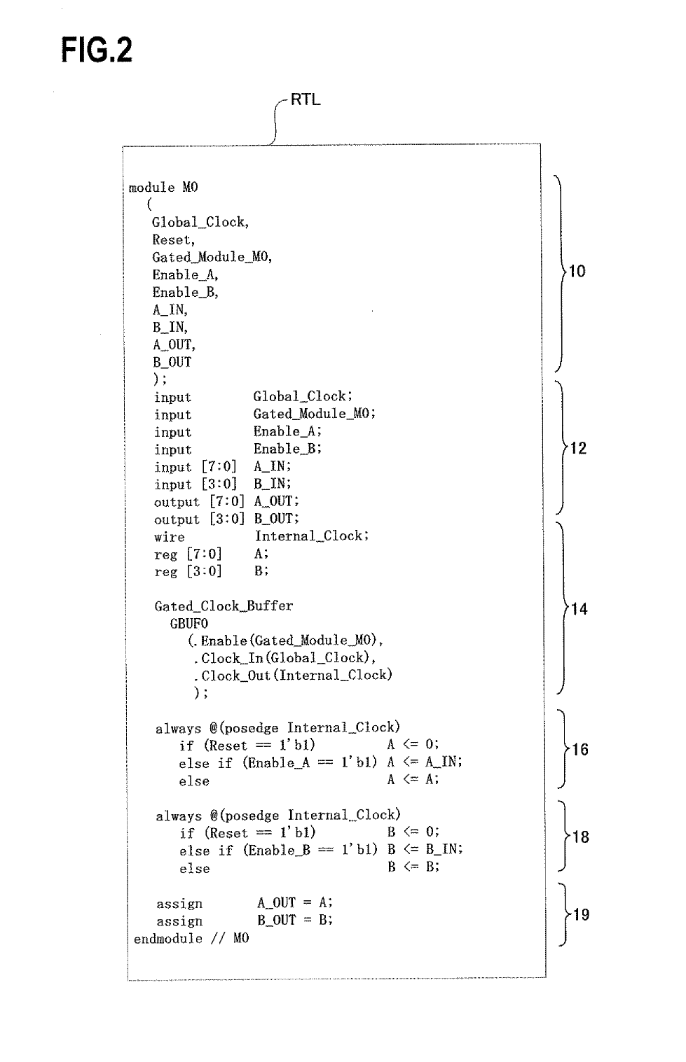

FIG. 2 shows an example of HDL design data. This design data RTL is for a module MO in which, when the enable signal A is “1”, the input A_IN is latched by the register A and output as the output A_OUT, and when the enable signal B is “1” the input B_IN is latched by the register B and output as the output B_OUT. The design data RTL has a module declaration 10, input/output declarations 12, wiring, register A (8 bits), register B (3 bits), and gated clock buffer GBUF0 declarations 14, and sequential circuit descriptions 16, 18. This design data is described in HDL; the contents of the above declarations are as described.

For example, according to the description of the sequential circuit 16, in response to the rising edge of the internal clock Internal13 Clock, if the reset signal Reset is “1” then register A is set to “0”, if the enable signal Enable_A is “1” then the input A_IN of register A is latched, and if the enable signal Enable_A is “0” then the latched state of register A is maintained. A similar configuration is described for register B in the sequential circuit description 18. In this way, registers A and B are designed so as to perform prescribed operation with clock synchronization, on the condition of enable signals.

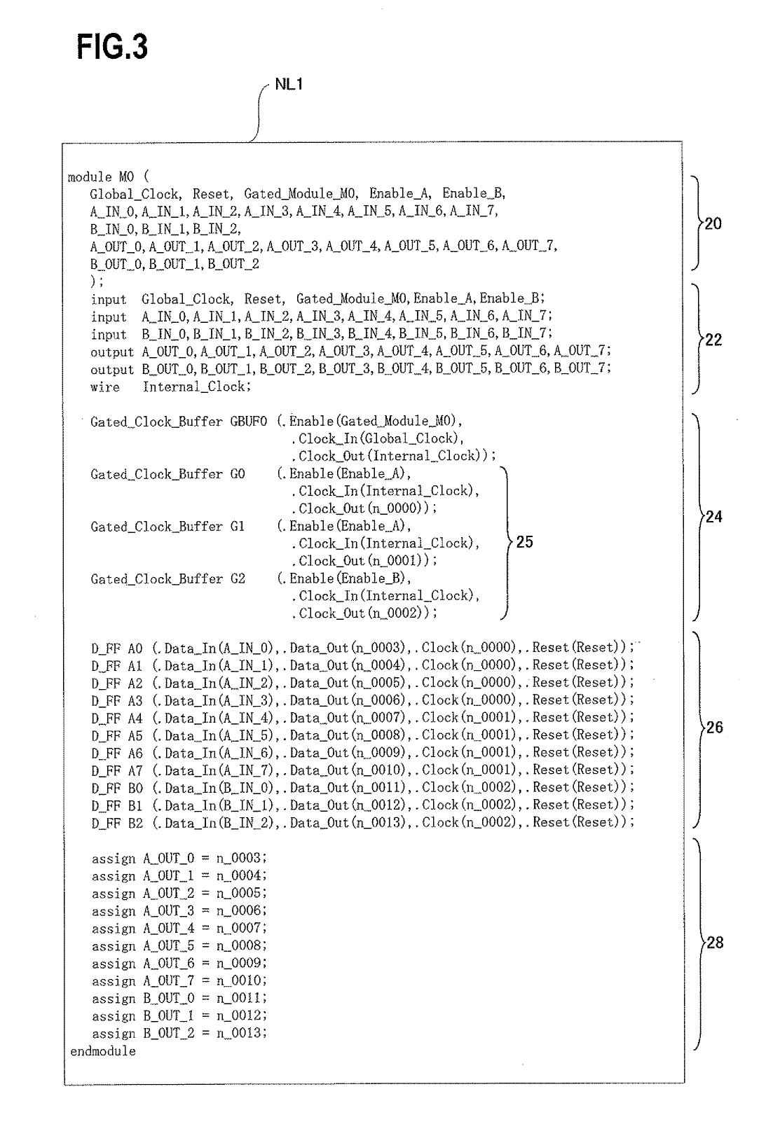

FIG. 3 shows an example of the netlist obtained by logic synthesis of the HDL design data RTL of FIG. 2. The logic synthesis tool references a cell library and converts the design data RTL into the netlist NL. The netlist NL1 shown in FIG. 3 has a wiring structure for a module 20, input/output 22, gated clock buffer group 24, D-FF group 26, and output terminal 28. In addition to the gated clock buffer GBUF0 declared in the design data RTL, gated clock buffers G0, G1, G2 are automatically inserted into this netlist NL1 as shown 25. The inserted gated clock buffers G0 and G1 output the input clock Internal Clock as the output clocks n_0000, n_0001 based on the enable signal Enable_A. The gated clock buffer G2 outputs the input clock Internal_Clock as the output clock n_0002 based on the enable signal Enable _B.

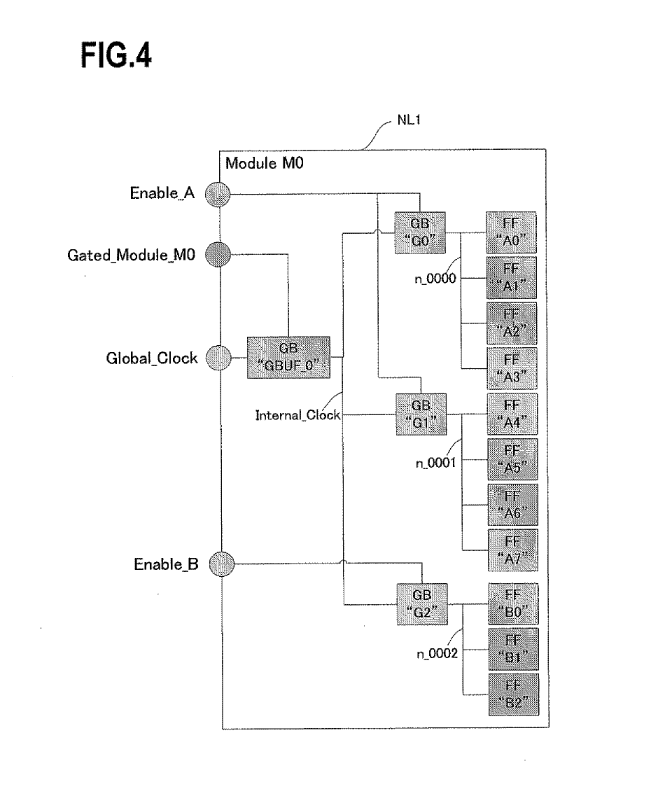

FIG. 4 is a logic circuit diagram for the netlist of FIG. 3. In FIG. 4, data input/output and data wiring are omitted, and the gated clock buffer GB, register (flip-flop) FF and other cells, as well as the clock input, enable input, and clock wiring, are shown.

The netlist defines connections by data lines and clock lines between buffers, flip-flops, and other cells. In the netlist of FIG. 3, clock wiring is such that a global clock Global_Clock input to the module MO is input to the gated clock buffer GBUF_0, an internal clock Internal_Clock is output, and this is supplied, via the gated clock buffers G0, G1, G3, to the registers A0 to A3, A4 to A7, and B0 to B2. Gate wiring is such that inputs A_IN_0 to A_IN_7 are connected to the data input terminals of registers A0 to A7, and the data output terminals are connected to the outputs A_OUT_0 to A_OUT_7, while inputs B_IN_0 to B_IN_2 are connected to the data input terminals of registers B0 to B2, and the data output terminals are connected to the outputs B_OUT_0 to B_OUT_2.

Further, in the netlist of FIG. 3, the enable signal Gated_Module_M0 is supplied to the gated clock buffer GBUF_0, the enable signal Enable_A is supplied to the gated clock buffers G0 and G1, the enable signal Enable_B is supplied to the gated clock buffer G2, and the reset signal Reset is supplied to each of the registers A0 to A7 and B0 to B2.

From the above explanation, the correspondence between the netlist NL1 of FIG. 3 and the logic circuit of FIG. 4 can be understood. And, in the logic circuit of FIG. 4, the cells GBUF_0, A0 to A7, and B0 to B2 are described in the HDL design data RTL, but it is seen that in the netlist NL1 generated by logic synthesis, the gated clock buffers G0, G1, G2 have been generated.

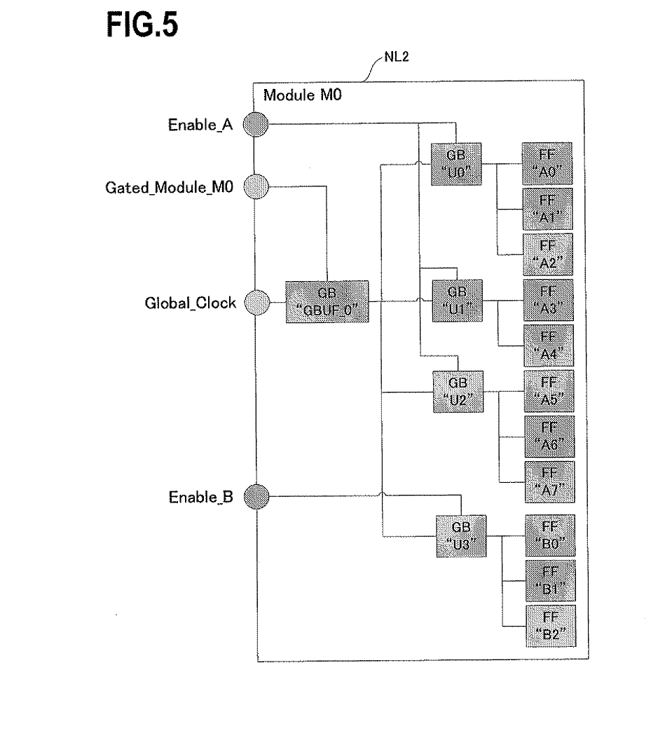

FIG. 5 is a diagram of the logic circuit corresponding to another netlist. FIG. 5 shows the logic circuit of netlist NL2, not shown. In this example, the design data RTL of FIG. 2 was provided to the logic synthesis tool together with a settings file having a command limiting the fanout of gated clock buffers to three, and the logic circuit of the netlist NL2 was obtained as a result. Similarly to the case of FIG. 4, the logic synthesis tool automatically inserts gated clock buffers U0 to U3 to conserve power. However, because the fanout is limited to three, the gated clock buffers U0, U1, U2 controlled by the enable signal Enable_A respectively supply clocks to the registers A0 to A2, A3 to A4, and A5 to A7. And, similarly to the netlist NL1 of FIG. 4, the buffer U3 controlled by the enable signal Enable_B supplies a clock to the registers B0 to B2. And, the automatically inserted buffer names U0 to U3 differ from the buffer names G0 to G2 of the netlist NL1.

In this way, even when the same design data is used, upon modifying a settings file and performing logic synthesis, different logic circuit netlists are generated. Similarly, if logic synthesis is performed using the logic synthesis tools of different vendors, although the logic circuits are equivalent, gated clock buffers with different buffer names are inserted, and different logic circuit netlists are generated. However, most of the cells are the same in the initial netlist and the modified netlist, the overall configuration is the same, and if it were possible to employ the power consumption calculation result calculated for the initial netlist to calculate the power consumption for the modified netlist, design costs could be reduced.

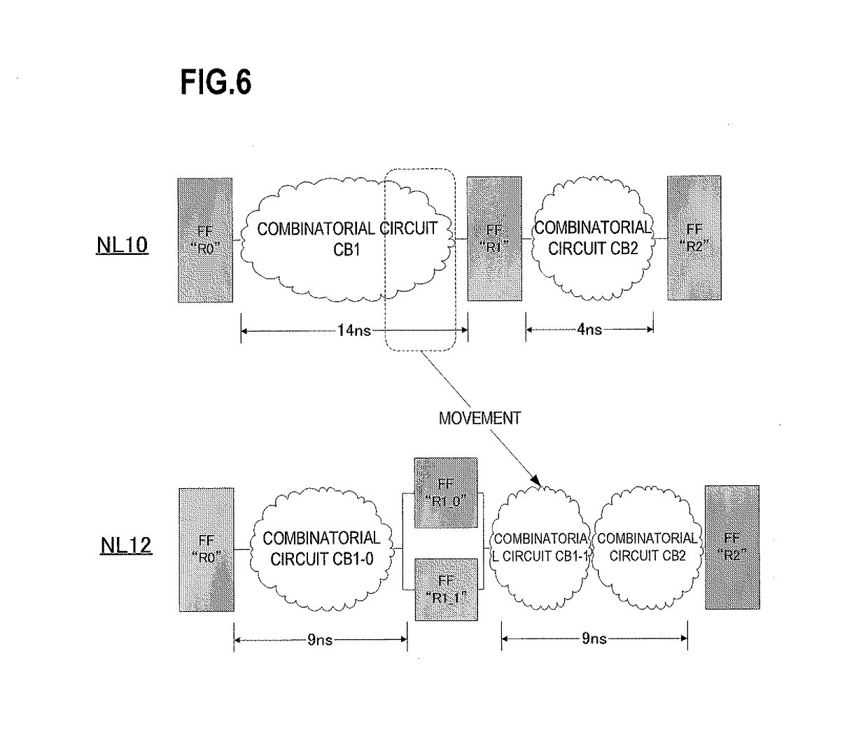

FIG. 6 explains retiming processing. Retiming processing also entails netlist modification. Hence in order to utilize a power consumption calculation result for the initial netlist, the data modified in retiming processing must be considered.

Retiming processing is processing in which registers which do not satisfy time constraints are moved such that delay time constraints between registers are satisfied; this processing is performed at the netlist stage. As shown in FIG. 6, in the netlist NL10, the combinatorial circuits CB1, CB2 exist between the registers R0, R1, R2. Suppose that the delay time in combinatorial circuit CB1 between registers R0 and R1 is 14 ns, and that the delay time in combinatorial circuit CB2 between registers R1 and R2 is 4 ns. If the constraint on delay times between registers is 12 ns, then the delay time of combinatorial circuit CB1 does not satisfy this time constraint.

Processing is therefore performed to move a portion of the combinatorial circuit CB1 to the right side, so as to satisfy the time constraint. This is retiming processing. In this case, processing is performed to delete register R1 in the netlist NL10 and insert a new register into combinatorial circuit CB1. Then, for reasons related to combinatorial circuit configuration and other reasons, two registers R1_0 and R1_1 are added. In this way, as a result of retiming processing, the names of corresponding registers in the two netlists NL10 and NL12 are changed, and the number increases. Calculation of power consumption is also necessary for the netlist NL12 which has been modified in this way.

In this way, register names may be changed and the number of registers may change in a modified netlist, so that in the process of power consumption calculation, it is necessary to determine the correspondence with the original netlist.

Taking into consideration the circumstances of a netlist generated by the above-described logic synthesis, the method of calculation of LSI power consumption of this embodiment is explained.

Method of Calculation of Power Consumption

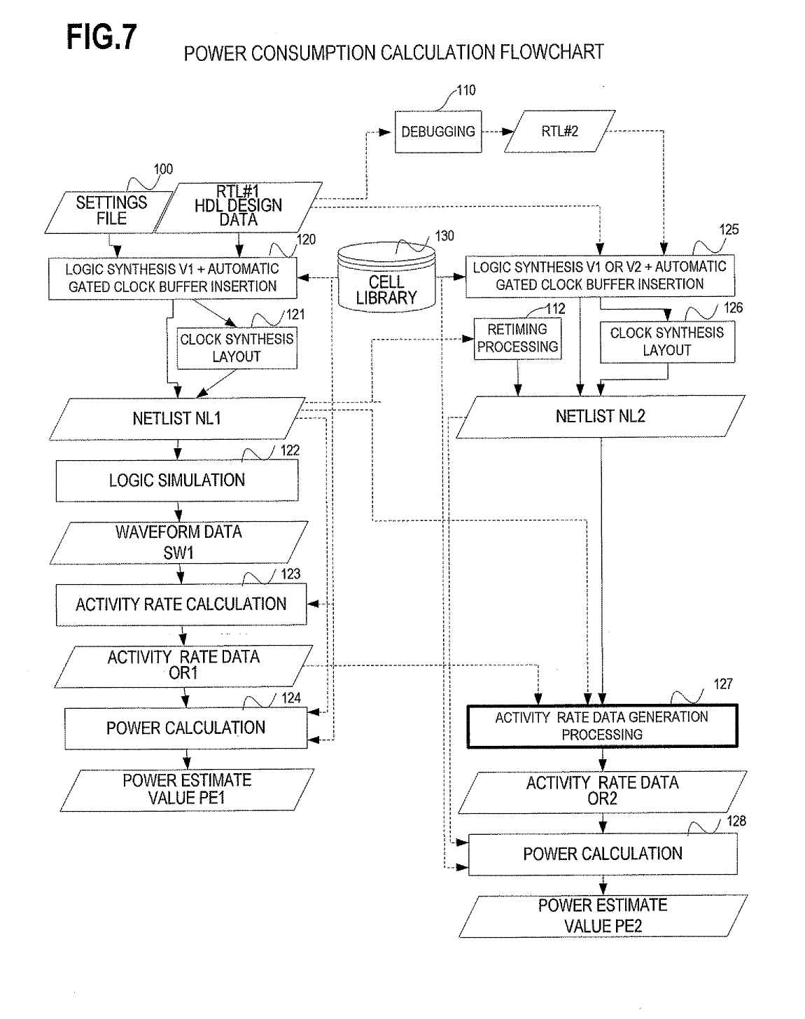

FIG. 7 is a flowchart of the method of calculation of LSI power consumption in this embodiment. The design data RTL#1, described in HDL, is subjected to logic synthesis under logic synthesis conditions set by a settings file 100, and converted into a netlist NL1 (120). This logic synthesis is performed by a logic synthesis tool (version V1), and as explained using FIG. 3, FIG. 4 and FIG. 5, for cells which take enable signals as operating conditions, gated clock buffers are automatically generated to input clock signals into cells according to enable signals.

After the logic synthesis 120, a clock synthesis and layout process 121 may be performed to insert clock buffers as appropriate midway in clock wiring, to improve clock signal propagation delays. Such a clock buffer is a simple buffer, and is not controlled by an enable signal. Hence such a clock buffer operates at the same activity rate as the upstream gated clock buffers.

Logic simulation is performed for the first netlist NL1 generated by logic synthesis (122). In logic simulation, the LSI defined by the netlist NL1 is made to operate, in synchronization with a clock signal, for a prescribed input pattern, and input/output waveform data SW1 is extracted over a desired interval for data lines, clock lines, and cells. This logic simulation process requires a huge number of machine-hours as the scale of the netlist is increased.

Activity rate data OR is calculated over the simulation period from the waveform data SW1 (123). For example, if clock signal waveform data always repeatedly changes between H level and L level then the activity rate is 100%, and if the waveform changes only for a portion of the interval, then the activity rate is the corresponding proportion. By this means, activity rates are obtained for the plurality of gated clock buffers in the netlist NL1.

Next, in the power calculation process 124, a power estimate value PE1 is calculated based on this gated clock buffer activity rate data, referring to the netlist NL1 and cell library 130. As explained above, the dynamic power consumption Pd is calculated using Pd=CV²fα (where C is the wiring capacitance, V the applied voltage, f the frequency (clock frequency), and α the activity rate). The wiring capacitance C is extracted from the cell library 130; the applied voltage V and clock frequency f are input separately.

According to the netlist NL1 shown in FIG. 4, the dynamic power consumption is calculated for the clock line Internal_Clock based on the activity rate of the gated clock buffer GBUF_0, and the dynamic power consumption is calculated for the clock lines n_0000 to n_0002 and for the registers A0 to A7 and B0 to B2 based on the activity rates of the gated clock buffers G0, G1, G2. In this way, signal lines and registers belonging to a certain gated clock buffer can be extracted by tracing the netlist NL1.

Through the above processing flow, the power consumption PE1 for the netlist NL1 is calculated. Next, the method of calculation of the power consumption of a netlist NL2, resulting from slight modification of this netlist NL1, is explained. FIG. 7 shows a case in which the second netlist NL2 is generated. For example, the HDL design data RTL#1 is debugged (110), slightly modified HDL design data RTL#2 is generated, and this is subjected to logic synthesis using the same logic synthesis tool (version V1) to generate the second netlist NL2. Second, the HDL design data RTL#1 or RTL#2 is subjected to logic synthesis by a different logic synthesis tool (version V2) to generate a second netlist NL2. Third, netlist NL1 is subjected to retiming processing (112), and the second netlist NL2 is generated. In addition to the above, a second netlist, which has input/output terminals and cells in common with the first netlist NL1, but with a different clock tree structure or different names for clock buffers forming the clock tree structure, or similar, can be generated under various other conditions.

In this embodiment, the power consumption of a slightly modified netlist NL2 is calculated, without repeating the logic simulation process which requires an enormous number of machine-hours. To this end, in activity rate data generation processing 127, activity rate data OR2 for the second netlist is generated from the first and second netlists NL1 and NL2, and from the activity rate data OR1 determined in logic simulation of the first netlist (127). This processing 127 is described in detail below. That is, activity rate data OR1 determined in logic simulation of the first netlist can also be used in calculating power for the second netlist. Then, based on activity rate data OR2 determined for the second netlist NL2, power calculation processing similar to that described above is performed to calculate a power estimate value PE2 (128).

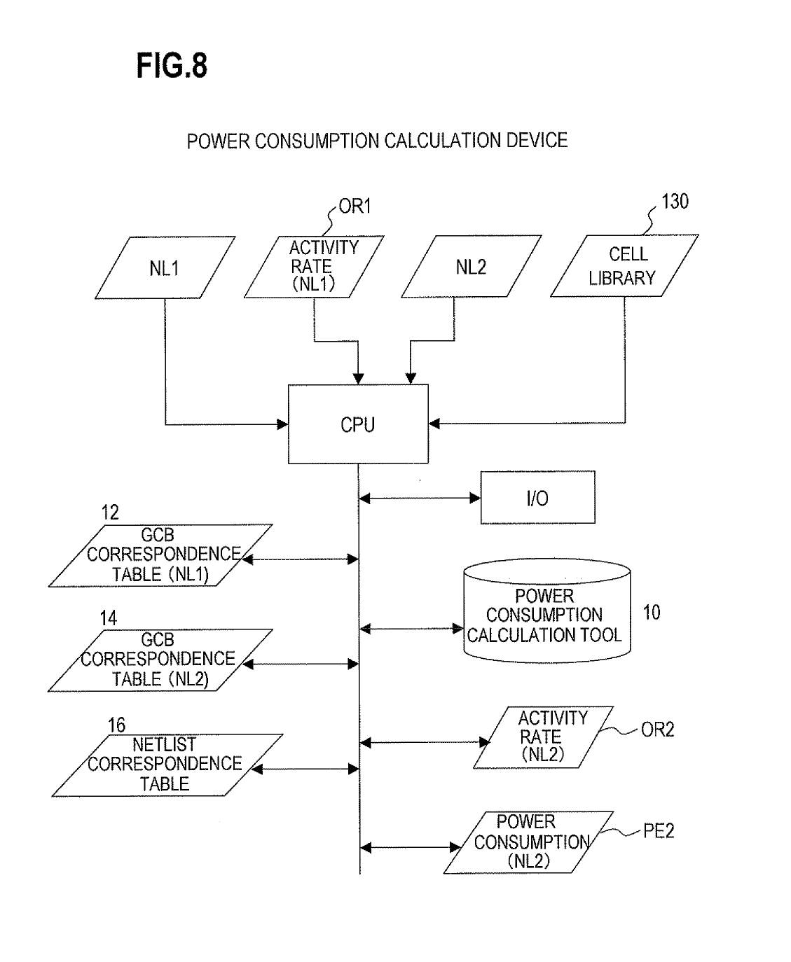

FIG. 8 shows the configuration of the power consumption calculation device of this embodiment. In this device, a central processing unit CPU performs calculations of power consumption by executing a power consumption calculation tool, which is a computer program. As explained using FIG. 7, the power consumption calculation tool 10 references the first and second netlists NL1 and NL2 and the cell library 130 to generate activity rate data OR2 for the second netlist from the activity rate data OR1 for the first netlist. In order to generate this activity rate data OR2, gated clock buffer correspondence tables 12, 14 for the first and second netlists NL1 and NL2, and a netlist correspondence table 16, are generated. Further, the power consumption calculation tool 10 calculates the power consumption PE2 based on this activity rate data OR2, referencing the second netlist NL2 and cell library 130.

Activity Rate Data Generation Processing

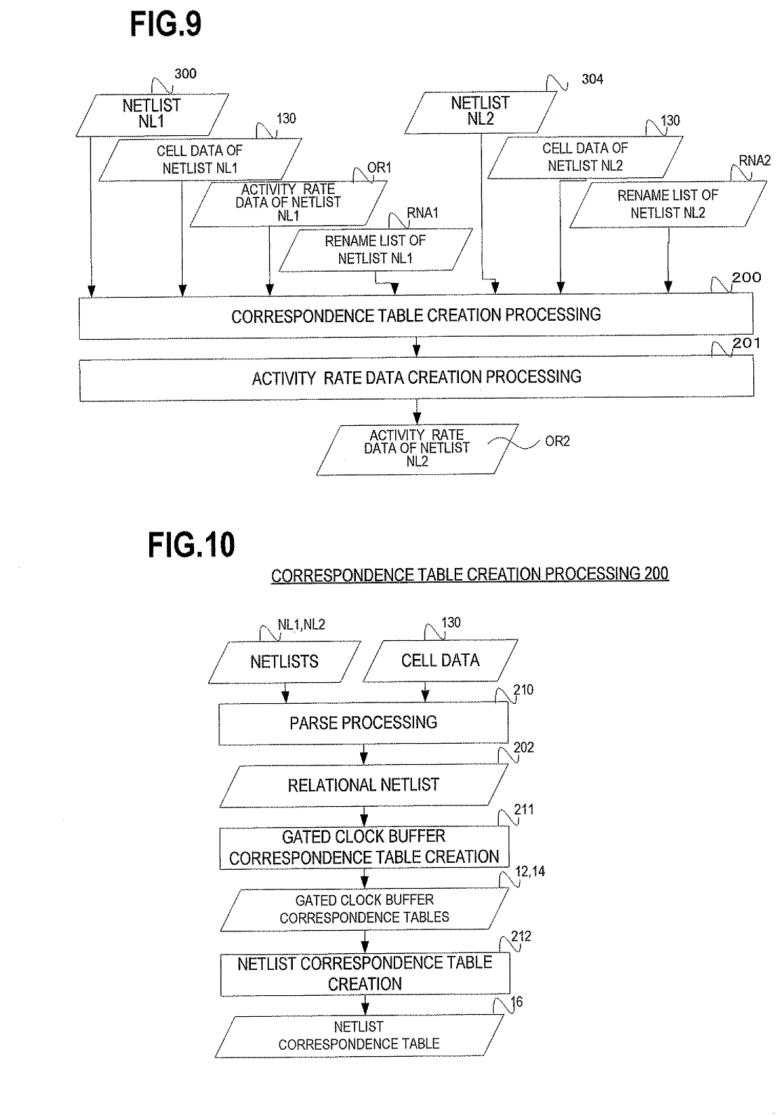

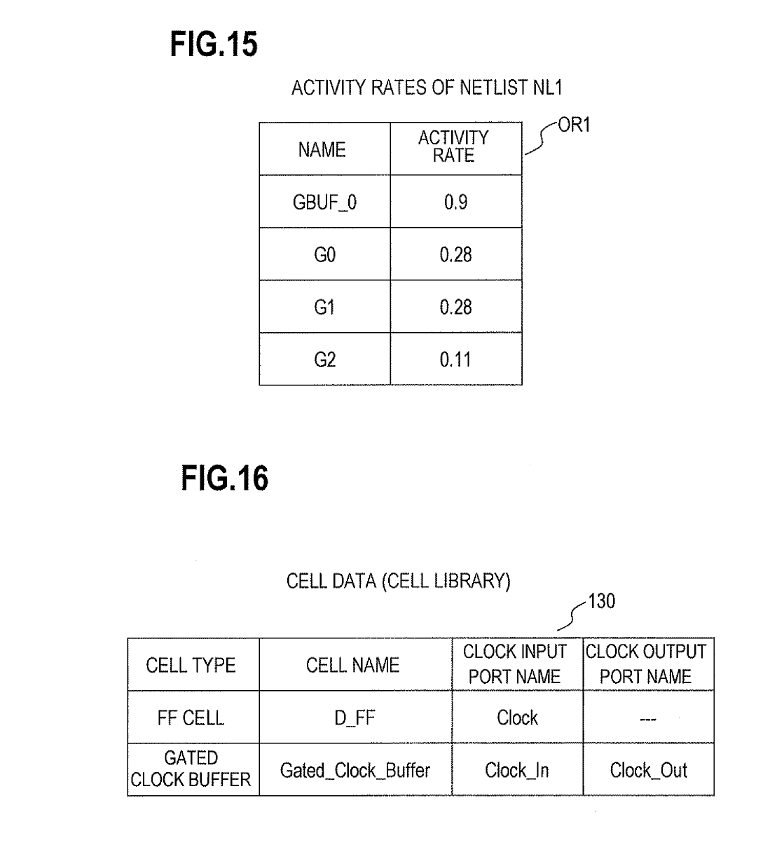

FIG. 9 through FIG. 14 are flowcharts of activity rate data generation processing 127 in this embodiment. An explanation is given for the specific example of the two netlists NL1, NL2 of FIG. 2 through FIG. 5; and in explaining these flowcharts, FIG. 15 through FIG. 23, which various data and tables generated upon application to this specific example, are referenced.

FIG. 9 is a flowchart of generation of activity rate data for netlist NL2. Processing to generate activity rate data OR2 comprises processing 200 to create a netlist cell correspondence table from the first and second netlists NL1 and NL2, and processing 201 to create operate rate data OR2 from the first netlist NL1 and activity rate data OR1 and the correspondence table. In the correspondence table creation processing 200, rename lists RNA1 and RNA2 are referenced in order to accommodate cases in which registers have been renamed, as a consequence of retiming processing or for other reasons. The activity rate data necessary for power calculations is the activity rates of gated clock buffers, and so the table of correspondence between netlists is also a gated clock buffer correspondence table.

FIG. 15 shows operate rate data OR1 for the first netlist NL1. As shown in FIG. 4, the first netlist NL1 has gated clock buffers GBUF_0, G0, G1, and G2; the activity rates for these are determined from logic simulation of the first netlist.

FIG. 16 shows cell data from the cell library 130. As an example, the cell data of FIG. 16 comprises cell names, clock input port names, and clock output port names for cell types of flip-flop cell and gated clock buffer.

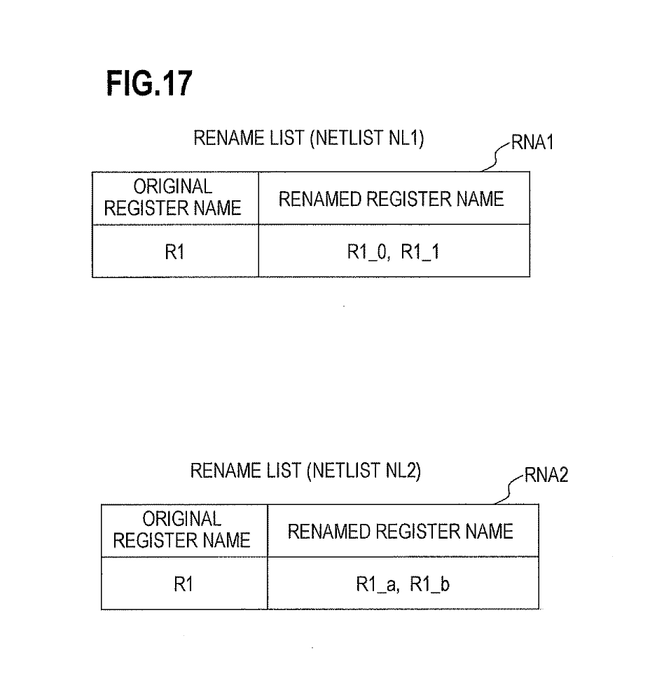

FIG. 17 shows examples of rename lists RNA1 and RNA2. Due to retiming processing or for other reasons, register names in a netlist are renamed to different register names. In such cases, rename lists RNA1, RNA2 are generated. Rename list RNA1 is an example for the first netlist NL1, and rename list RNA2 is an example for the second netlist NL2. However, such renaming is not performed for the netlists of FIG. 4 and FIG. 5.

Correspondence Table Creation

FIG. 10 is a flowchart of the correspondence table creation processing 200 of FIG. 9. First, the cell data 130 of the library (FIG. 16) is referenced, and parse processing of the netlist is performed to generate a relational netlist 202 (210). The relational netlist generated in this parse processing is an intermediate file generated for use in generating the correspondence table described below.

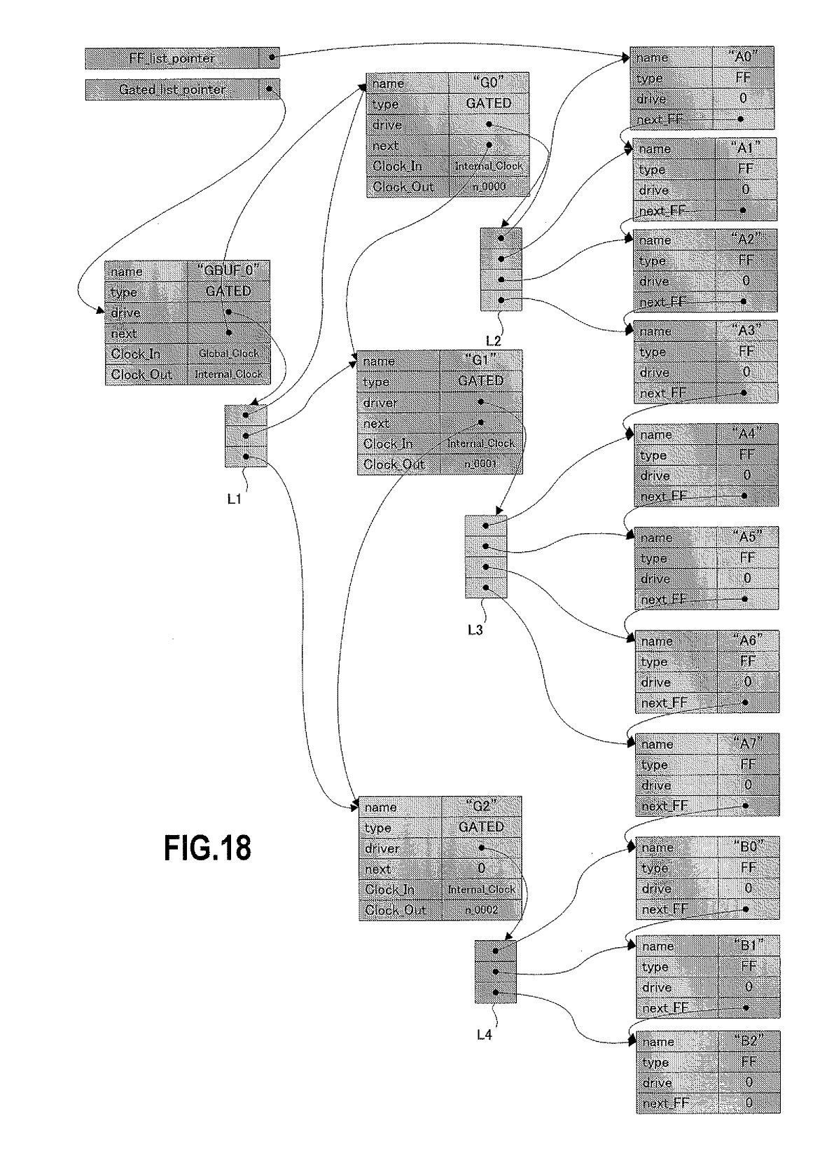

FIG. 18 shows the relational netlist corresponding to the first netlist NL1. This relational netlist comprises the gated clock buffers GBUF_0, G0, G1, G2, as well as the flip-flops A0 to A7 and B0 to B2 which are registers, and clock wiring connecting these. These buffers and registers are types of cell. The gated clock buffers are linked by gated list pointers. A pointer to the next buffer is stored in the “next” field of each buffer. Similarly, flip-flops are linked by FF list pointers. In the same way, a pointer to the next flip-flop is stored in the “next” field of each flip-flop. Further, a pointer to the buffer and register of the following stage driven by the output clock is stored in the “drive” field. When driving a plurality of following-stage cells, pointers are stored in lists L1, L2, L3, L4. And, in the case of a gated buffer, actual clock wire names are stored in the fields “Clock_In” and “Clock_Out”.

Returning to FIG. 10, through parse processing, relational netlists 202 such as that described above are created in memory space for each of the first and second netlists NL1 and NL2. These relational netlists are searched, and gated clock buffer correspondence tables 12, 14 are created (211).

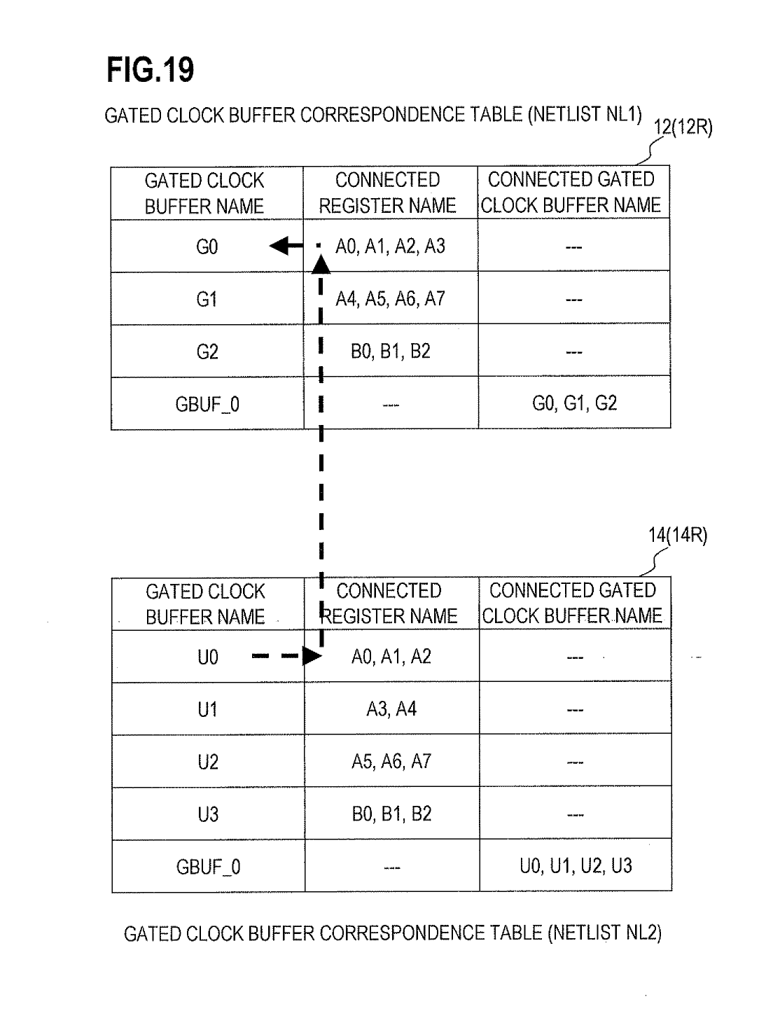

FIG. 19 shows examples of gated clock buffer correspondence tables. The gated clock buffer correspondence table 12 for the first netlist NL1 can easily be understood by referring to the netlist NL1 of FIG. 4. That is, the gated clock buffers G0, G1, G2 supply clocks to the registers A0 to A3, A4 to A7, and B0 to B2, respectively. And, the gated clock buffer GBUF_0 supplies clock signals to the lower-level gated clock buffers G0, G1, G2. Hence these correspondence relations are indicated in the correspondence table 12.

Similarly, the gated clock buffer correspondence table 14 for the second netlist NL2 can easily be understood by referring to the netlist NL2 of FIG. 5. The gated clock buffers U0, U1, U2, U3 supply clocks to the registers A0 to A2, A3 to A4, A5 to A7, and B0 to B2, respectively. The gated clock buffer GBUF_0 supplies clock signals to the lower-level gated clock buffers U0, U1, U2, U3. Hence the correspondence table 14 indicates these correspondence relations.

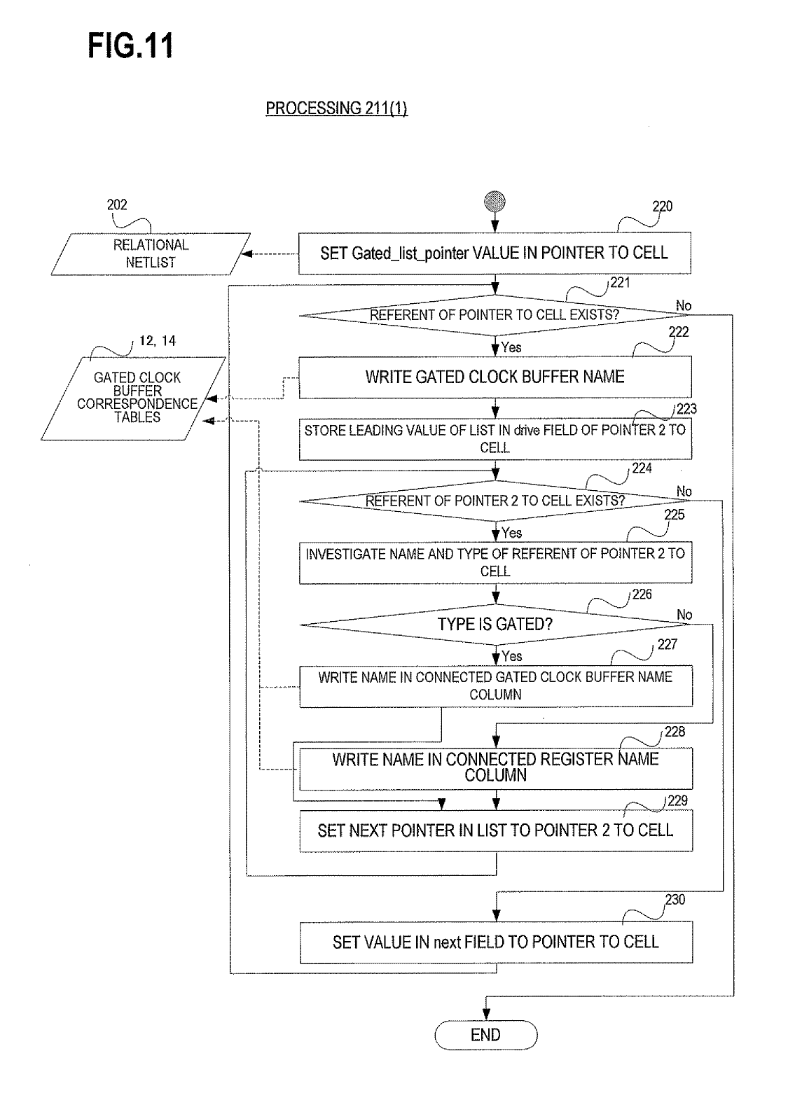

FIG. 11 is a flowchart of gated clock buffer correspondence table creation. Here, while tracing gated clock buffers in the relational netlist 202 of FIG. 18, the cell names and types to which clock signals are supplied by each gated clock buffer are referenced, and cell names are classified by type, so that the gated clock buffer correspondence tables 12, 14 of FIG. 19 are created.

Specifically, the value of the gated list pointer is set in the cell pointer (220), and a check is performed to determine whether the referent of the cell pointer exists (221). The first referent is the gated clock buffer GBUF_0. Hence the name of the gated clock buffer which is the referent is written in the correspondence tables 12, 14 (222). Then, the pointer value at the beginning of list L1 of the “drive” field is stored in the pointer 2 to the cell (223). A check is performed to determine whether the referent of this pointer value exists (224), the name and type of the referent are checked (225), and if the type is “GATED” (226), the name is written in the connected gated clock buffer column of the correspondence table (227). If the type is flip-flop “FF” or another register, the name is written in the connected register column of the correspondence table (228). The above processing 224 to 228 is repeated for all the pointers in the lists L1, L2, L3, L4 stored in the pointer 2 to cells.

As indicated in the correspondence table 12 of FIG. 19, as a result the names of connected gated clock buffers G0, G1, G2 are written for the gated clock buffer GBUF_0.

Next, if the referent of the pointer 2 to a cell does not exist (NO in 224), the value in the “next” field is set for the pointer to a cell (230). That is, in the example of FIG. 18, the cell of the gated clock buffer G0 is selected. The name and type of the cell which is the referent of list L2 in the “drive” field for this cell G0 are checked, and writing to the correspondence table is similarly performed. Similar processing is repeated for the gated clock buffers G1 and G2 also. Then, in the case of the gated clock buffer G2, there exists no referent of the pointer to a cell (NO in 221), and so processing ends.

As described above, while tracing all the gated clock buffers, the cells to which these gated clock buffers supply clock signals are classified as either gated clock buffers or registers, and the gated clock buffer correspondence table 12 of FIG. 19 is created. Similar processing is performed for netlist NL2 to create the correspondence table 14.

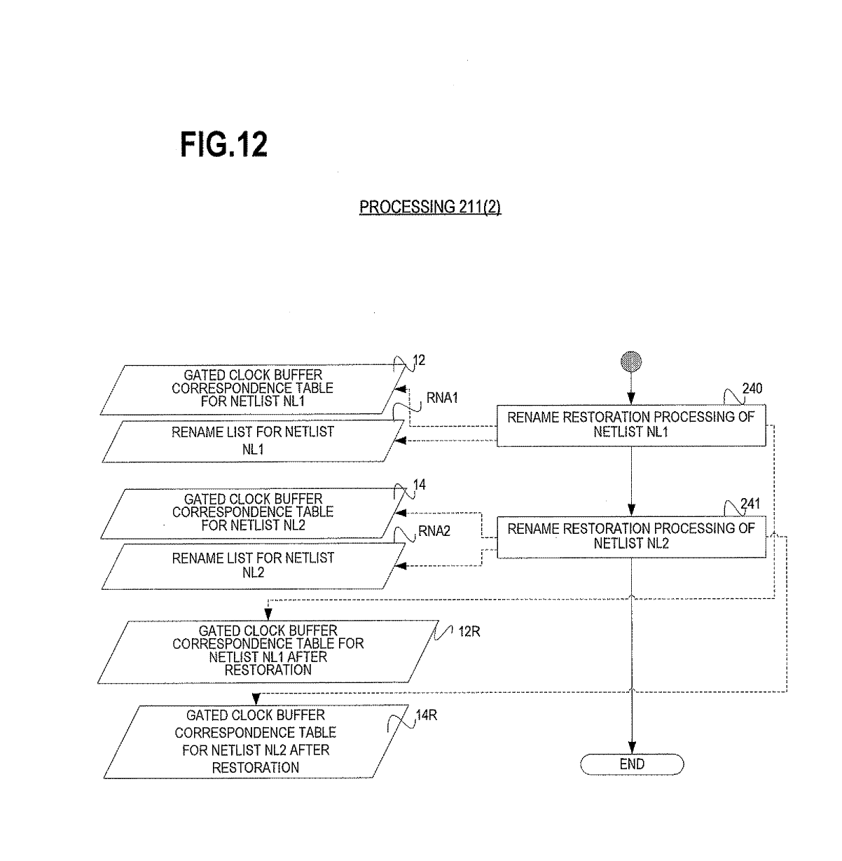

FIG. 12 is a second flowchart of gated clock buffer correspondence table creation. This flowchart described processing necessary when register names are changed due to retiming processing or for other reasons. That is, when a register name written to the gated clock buffer correspondence table 12 exists in the rename list RNA1, the register name is restored, that is, returned to the original register name (240). In other words, in the case of the rename list RNA1 of FIG. 17, the renamed register names R1_0, R1_1 are returned to the original register name R1. Similarly for the gated clock buffer correspondence table 14, the rename list RNA2 is referenced, and register names which have been changed are returned to the original register names (241). As a result, correspondence tables 12R, 14R having the respective original register names are generated. This is because, in order to detect correspondences of gated clock buffers between the netlists, searches are performed using register names, and so it is necessary that the correspondence tables 12R, 14R have common original register names.

In this way, through structural analysis of each of the netlists NL1 and NL2, the gated clock buffer correspondence tables 12 and 14 of FIG. 19 can be created. When a rename list exists, the correspondence tables 12R, 14R (or 12R, 14R) are created. Then, the correspondence tables 12, 14 are utilized to create a netlist correspondence table 16, indicating the correspondence of gated clock buffers between the netlists NL1 and NL2. Searching of these correspondences is performed moving upstream from the downstream side of the clock tree.

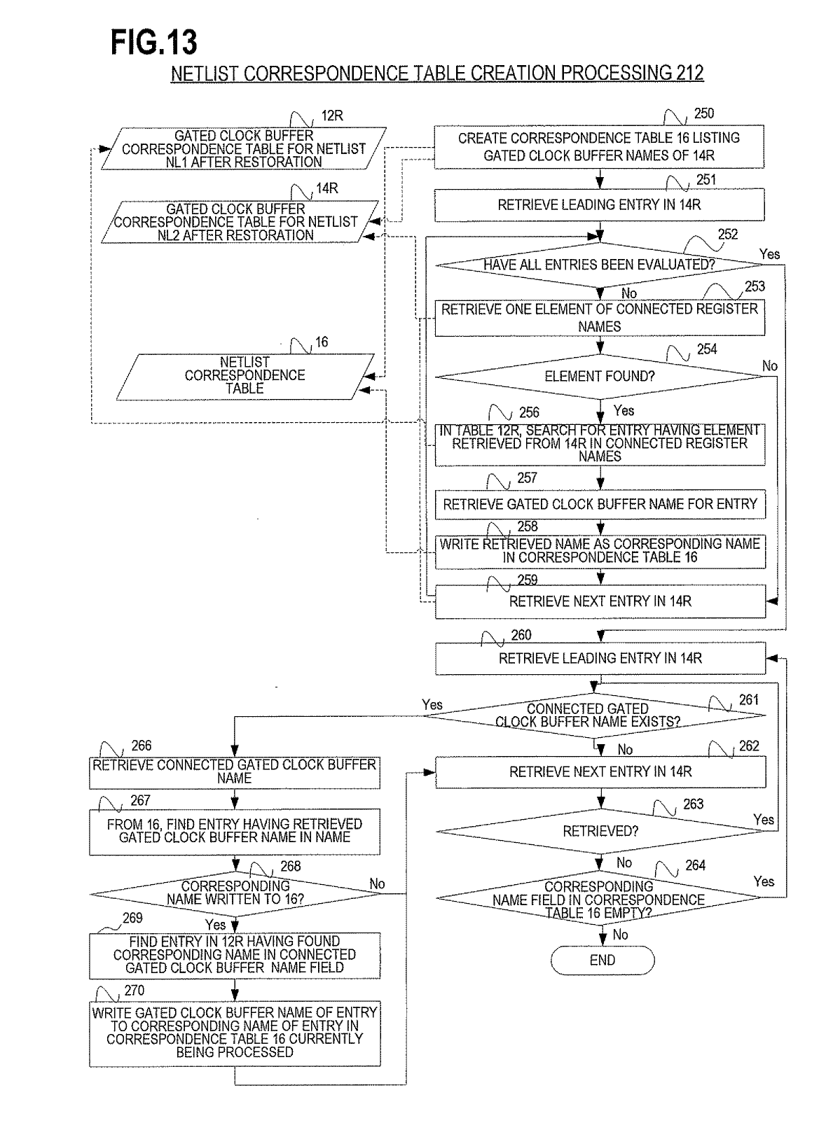

FIG. 13 is a flowchart of netlist correspondence table creation. Before explaining this flowchart, the method of searching for correspondences between gated clock buffers is explained.

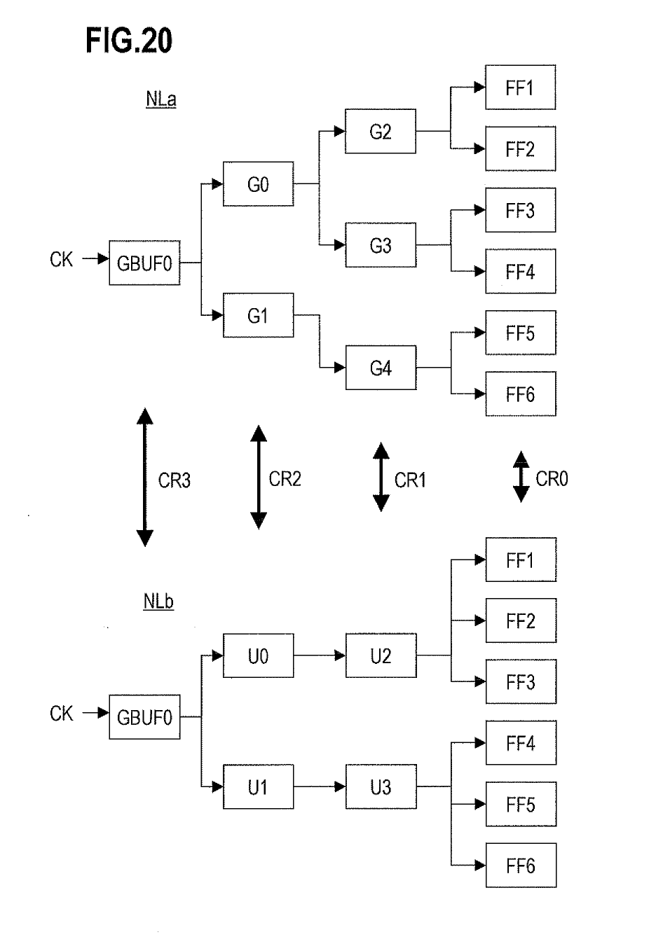

FIG. 20 explains a search algorithm for a netlist correspondence table. In this example, searching is performed for correspondences of gated clock buffers between the netlists NLa and NLb. Similarly to FIG. 4 and FIG. 5, only the clock trees of these netlists are shown.

The logic synthesis tool automatically inserts a gated clock buffer into the stage preceding a register in order to reduce power consumption. Hence changes in the configuration and names of gated clock buffers which are automatically inserted upon each logic synthesis are anticipated. However, in HDL design data, inputs and outputs and registers are defined by the designer, and are not changed even upon logic synthesis. Hence in searching for gated clock buffer correspondences, gated clock buffers supplying clocks to the same registers are sought, starting with the registers furthest downstream from the clock, FF1 to FF6, correspondences between these are detected, and starting from a gated clock buffer for which a correspondence has been detected, buffers to which the same gated clock buffer provides clocks are sought. Searching is repeated, moving to gated clock buffers further upstream.

In the example of FIG. 20, the corresponding CR0 has the same register names, so that detection is easy; based on corresponding CR0, the corresponding CR1 are detected, and based on the corresponding CR1 the CR2 and CR3 are detected. By this means, even when the number and names of gated clock buffers are different, correspondence relations can be found.

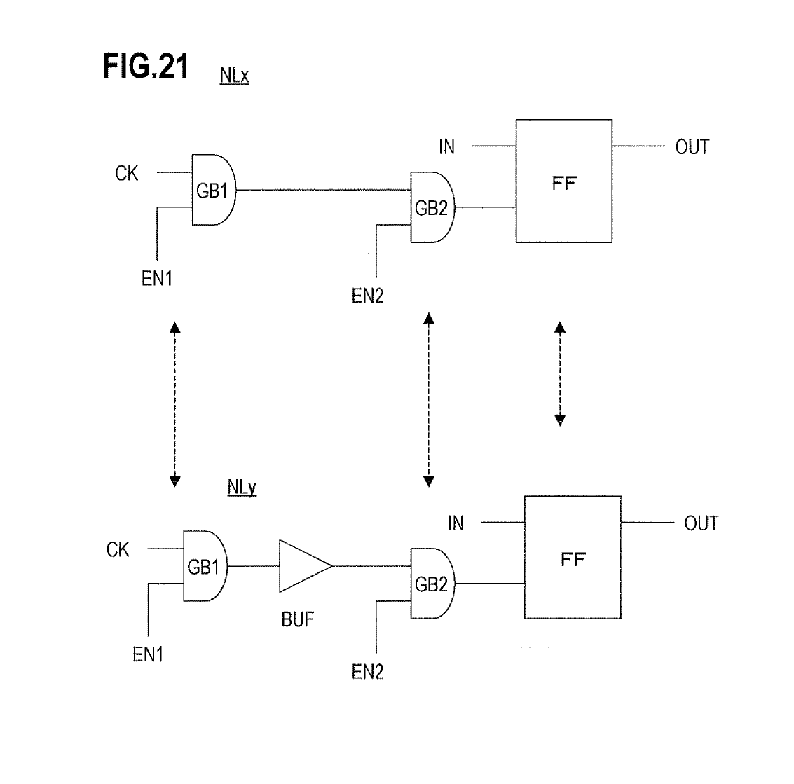

FIG. 21 is another figure explaining an algorithm for searching a netlist correspondence table. In this example, a search for correspondences between netlists NLx and NLy is shown. In netlist NLx, a gated clock buffer GB2 is added immediately before register FF. Also, a buffer BUF is added between the gated clock buffers GB1 and GB2 of this netlist NLx to improve the clock delay, generating the netlist NLy. In this case, as explained using FIG. 11 and FIG. 13, the netlists are analyzed, and tables 12, 14 of correspondences between gated clock buffers and the registers and gated clock buffers to which they are connected are generated, so that the inserted buffer BUF is excluded from the search of correspondences between netlists. Hence correspondence relations between the two can be detected as indicated by the arrows in FIG. 21.

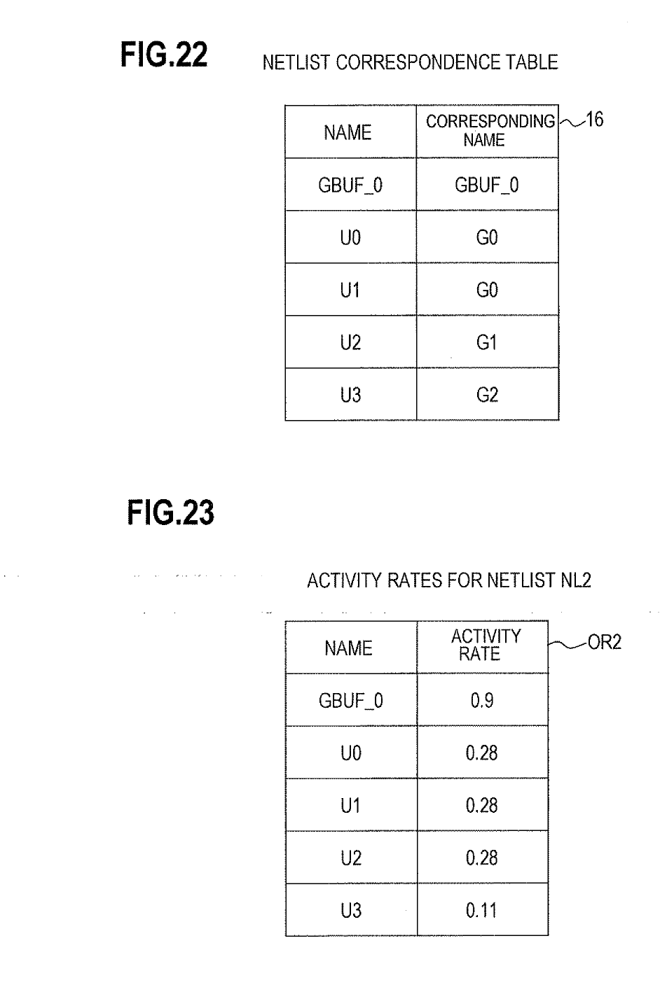

FIG. 13 is a flowchart of netlist correspondence table creation processing. This creation processing involves creation of a correspondence table between netlists from the gated clock buffer correspondence tables 12 and 14 of FIG. 19, based on the above search algorithms. First, a correspondence table 16 is created (250) which lists the names of gated clock buffers within the correspondence table 14R for the second netlist NL2. An example of such a correspondence table 16 appears in FIG. 22. That is, gated clock buffer names for the second netlist NL2 are arranged in the left-hand “names” column of the correspondence table 16, and in the right-hand “corresponding names” column are arranged gated clock buffer names for the first netlist NL1. At the stage of the above process 250, the right-hand column is completely empty.

Next, the leading entry in the correspondence table 14R is retrieved, and the name of the connected registers corresponding to the gated clock buffer of this entry are retrieved (251, 252, 253). Taking the correspondence table 14R in FIG. 19 as an example, the entry for the gated clock buffer U0, which is the first entry, is retrieved, and the corresponding connected register name A0 is retrieved. The gated clock buffers are not necessarily arranged as in the example of FIG. 19, and so there may be entries for which there are no connected register names. When a register name element is found (Yes in 254), this means that the entry is an entry for a gated clock buffer which supplies a clock signal to a register. Hence the correspondence table 12R for netlist NL1 is searched for an entry with the same register name (256). As indicated by the broken-line arrow in FIG. 19, the gated clock buffer G0 of the entry having the connected register A0 is retrieved (257), and this is written in the right-hand “corresponding name” column of the correspondence table 16 (258). Then, the next entry in the correspondence table 14R is retrieved (259), and the above processing is repeated.

In this way, processes 251 to 259 perform processing which takes connected registers as starting-points to search for correspondences between gated clock buffers which provide clock signals to the registers.

Next, after processing of entries in the correspondence table 14R having connected register names is completed, a search of the correspondence table 14R is again performed from the first entry (260). For entries in which a connected gated clock buffer name exists (Yes in 261), that is, for a gated clock buffer which supplies a clock signal to a gated clock buffer, the connected gated clock buffer name is retrieved (266). In the example of FIG. 19, the entry for gated clock buffer GBUF_0 is retrieved, and the connected gated clock buffer name U0 is retrieved. Then, an entry in the correspondence table 16 having the connected gated clock buffer name U0 in the left-hand “name” column is found (267) When data is written in the right-hand “corresponding name” column for this entry (Yes in 268), with the correspondence table 12R, an entry having the corresponding name G0 as the connected gated clock buffer name is found (269), and the gated clock buffer name GBUF_0 for this entry is written in the entry of the correspondence table 16 currently being processed, in the right-hand “corresponding name” column (270).

When in process 268 the right-hand “corresponding name” column in the correspondence table 16 is empty, this entry is skipped, the next entry in the correspondence table 14R is retrieved, and processes 261 and 266 to 270 are repeated. That is, as explained using FIG. 20, a correspondence relation CR1 is detected, and based on the gated clock buffer written in the correspondence table 16, the correspondence CR2 to the upstream gated clock buffer is sought. Using the example of FIG. 20 in the explanation, even when a correspondence with gated clock buffer GBUF _0 is sought, if the correspondence relation CR2 is not detected, retrieval is not possible. Hence searching is performed from the correspondence of the gated clock buffer one level upstream from the buffer for which a correspondence relation is detected. However, in the example of FIG. 4 and FIG. 5, there are only two buffer levels, and so in the processing of 268 a No result does not occur.

By repeating the above searches, the correspondence relations of FIG. 20 are detected in the order CR1, CR2, CR3. Then, upon repeating processing until the right-hand “corresponding name” column in the correspondence table 16 does not have empty (264), the processing of FIG. 13 ends. As a result, the netlist correspondence table 16 shown in FIG. 22 is generated.

Creation of Activity Rate Data

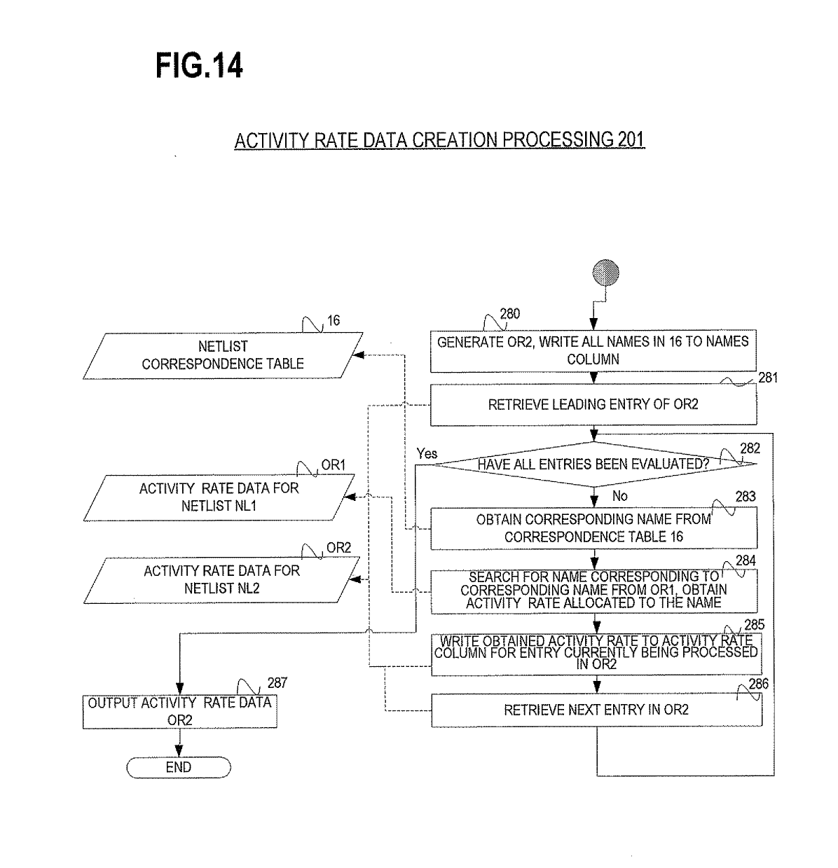

FIG. 14 is a flowchart of the activity rate data creation processing 201. The activity rate data OR2 (FIG. 23) of the second netlist NL2 is generated from the activity rate data OR1 (FIG. 15) for the first netlist NL1 and the netlist correspondence table 16 (FIG. 22). That is, gated clock buffers which are in a correspondence relation in the netlist correspondence table 16, though having different names, are buffers controlled by the same enable signals, and have the same activity rates. Hence activity rate data can be shared between buffers in a correspondence relation in the netlist correspondence table 16.

As is clear from FIG. 15, FIG. 22, and FIG. 23, the buffer GBUF_0 has an activity rate of 0.9, the buffers U0 and U1 have the same activity rate of 0.9 as the buffer G0, the buffer U2 has the same activity rate of 0.28 as the buffer G1, and the buffer U3 has the same activity rate of 0.11 as the buffer G2. In this way, if the correspondence relations between gated clock buffers are found, then activity rates determined through logic simulation of the first netlist NL1 can be utilized as the activity rates for the second netlist NL2.

The flowchart of FIG. 14 is explained. A table of activity rate data OR2 is generated, and all the names of the netlist correspondence table 16 are written in the name column thereof (280). In the example of FIG. 23, the buffer names GBUF_0, U0, U1, U2, U3 are written in the left-hand “name” column. Next, the leading entry GBUF_0 of the activity rate table OR2 is retrieved (281), and GBUF_0 corresponding thereto is retrieved from the left-hand “corresponding name” column of the correspondence table 16 (283). The activity rate of 0.9 for this corresponding name GBUF_0 is sought from the activity rate data OR1 (284), and this activity rate 0.9 is written to the activity rate column of the activity rate table OR2 (285). Then, the next entry in the activity rate table OR2 is retrieved, and the above processing 283 to 286 is repeated. When all entries have been processed (Yes in 282), processing is completed.

As described above, in the above embodiment the first and second netlists are analyzed, the correspondence relation between gated clock buffers and registers is detected, and from this information, a gated clock buffer correspondence table 16 between netlists is acquired. Relying on this correspondence table 16, the activity rate data OR2 for the second netlist NL2 is acquired from the activity rate data OR1 for the first netlist NL1. As a result, there is no need to repeat a logic simulation of the second netlist NL2.

### Another Embodiment

In another embodiment, given the assumption of generation of a table of gated clock buffers being automatically generated by the logic synthesis tool corresponding to enable signals, the tables of generated gated clock buffers generated at the time of logic synthesis of each of the netlists NL1 and NL2 are referenced, and the same enable signal names are used to search for gated clock buffer correspondence relations. Hence the logic synthesis tool needs to have a function of generating a table of generated gated clock buffers.

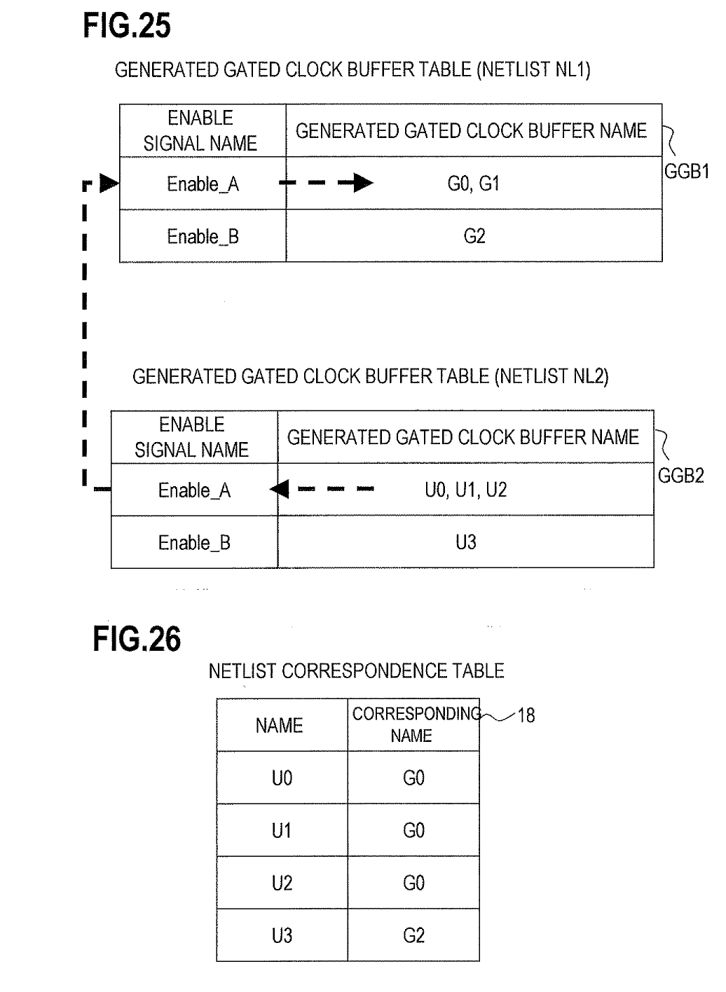

FIG. 25 shows a generated gated clock buffer table. In these tables GGB1 and GGB2, gated clock buffers which have been automatically generated for the netlists NL1 and NL2 of FIG. 4 and FIG. 5 respectively are associated with enable signal names. In the table GGB1 for netlist NL1, the generated gated clock buffer names G0, G1 are associated with-enable signal Enable_A, and the generated gated clock buffer name G2 is associated with enable signal Enable_B. Similarly in table GGB2 for netlist NL2, the generated gated clock buffer names U0, U1, U2 are associated with enable signal Enable _A, and the generated gated clock buffer name G3 is associated with enable signal Enable_B.

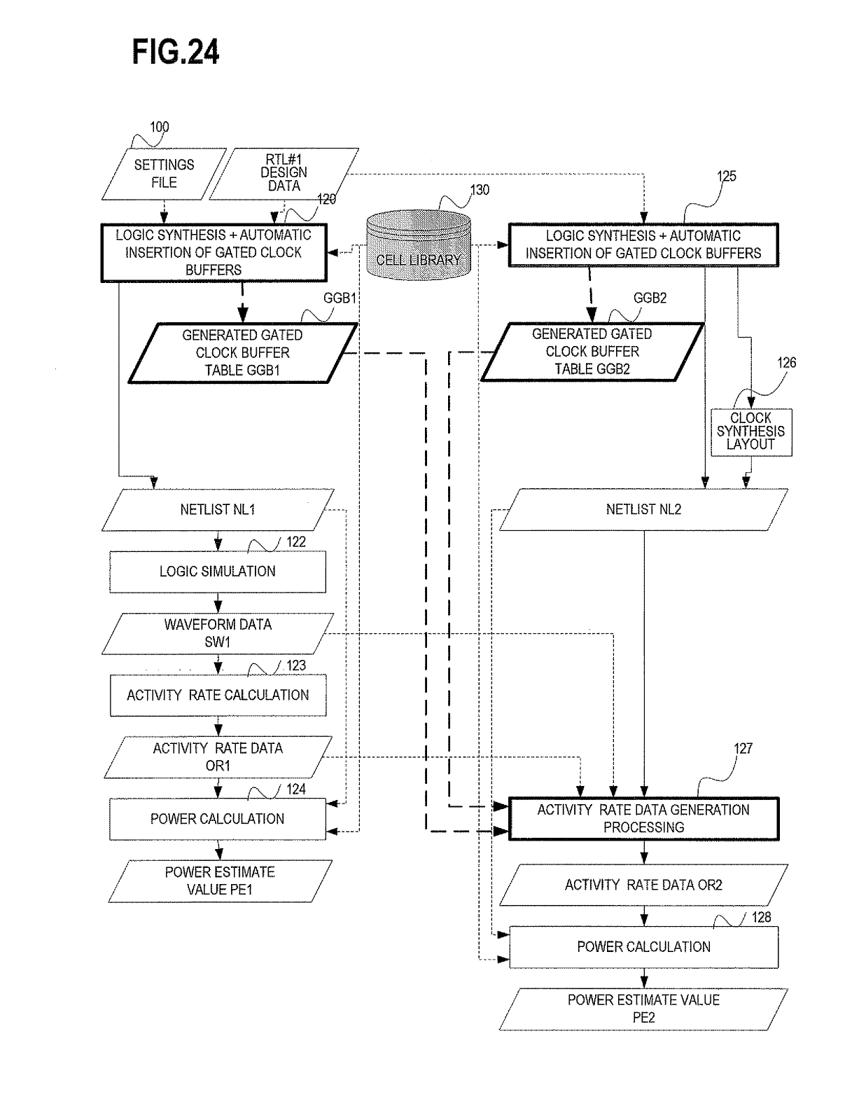

FIG. 24 is a flowchart of the LSI power consumption calculation method of this embodiment. In FIG. 24, the logic simulation 122, activity rate calculation processing 123, and power calculation processing 124 are executed in advance for netlist NL1. Then, for netlist NL2, gated clock buffer activity rate data OR2 for the netlist NL2 is generated (127) from the generated gated clock buffer tables GGB1, GGB2 and the activity rate data OR1, and this activity rate data OR2 is used in power calculations (128).

In this activity rate data generation processing 127, the netlist correspondence table 18 of FIG. 26 is generated based on enable signals in the generated gated clock buffer tables GGB1 and GGB2. This netlist correspondence table 18 differs from the correspondence table 16 of FIG. 22 in not comprising the gated clock buffer GBUF_0 that was not automatically generated. Corresponding activity rates are inserted into the activity rate data OR2 from the activity rate data OR1 according to this netlist correspondence table 18. Because the same name is maintained for the gated clock buffer GBUF_0 which was not automatically generated, the activity rate for this buffer is extracted from the activity rate data OR1 and inserted into the activity rate data OR2.

The principle of another embodiment consists in the fact that gated clock buffers controlled by the same enable signal have the same activity rate. Hence if a table can be created which associates gated clock buffers automatically generated by the logic synthesis tool with enable signals, then based on this table, activity rate data for the modified netlist can be extracted from the activity rate data for the netlist prior to modification.

What is claimed is:

1. An LSI power consumption calculation method, for calculating power consumption of LSI,
the method comprising:
executing logic simulation for a first netlist and determining activity rates for the cells, and calculating power consumption for the first netlist from the activity rates and from power consumption attribute parameters for the cells; and
calculating power consumption for a second netlist having at least a portion of the cells of the first netlist, and
detecting correspondence relations between cells in the first and second netlists;
determining activity rates for each cell of the second netlist from activity rates for the first netlist, based on the cell correspondence relations; and
calculating a second calculation of power consumption from the activity rates for each cell of the second netlist and from the power consumption attribute parameters for the cells.

2. The LSI power consumption calculation method according to claim 1, wherein the first and second netlists include: as the cells, a plurality of gated clock buffers which form clock trees and which propagate clock signals in response to enable signals; and registers to which the clock signals of the clock trees are supplied, and wherein
in detecting the correspondence relation, lower-level gated clock buffers coupled to a register with the same name in the first and second netlists are detected, the upper-level gated clock buffers to which the detected lower-level gated clock buffers are coupled in the first and second netlists are detected, and detection of upper-level gated clock buffers is repeated, to extract correspondence relations between detected gated clock buffers on each level.

3. The LSI power consumption calculation method according to claim 2, wherein, the detecting correspondence relation includes, generating first and second relational netlists from the first and second netlists respectively, associating the gated clock buffers with the registers and with the gated clock buffers, and searching the first and second relational netlists to extract correspondence relations between the gated clock buffers.

4. The LSI power consumption calculation method according to claim 2, wherein, in the second calculation power consumption of the second netlist is determined according to activity rates of the gated clock buffers, power consumption attribute parameters for cells to which an output clock of the gated clock buffers is supplied, and a clock frequency and power supply voltage.

5. The LSI power consumption calculation method according to claim 1, wherein
a plurality of gated clock buffers which form clock trees and which propagate clock signals in response to enable signals, and registers to which clock signals of the clock trees are supplied are included in the first and second netlists as the cells;
in detecting the correspondence relation, the gated clock buffers of the first and second netlists, which are controlled by the same enable signal, are associated; and
in determining activity rates, the activity rates of each gated clock buffer of the second netlist are determined from the activity rates of the first netlist based on the gated clock buffer correspondence relations.

6. The LSI power consumption calculation method according to claim 5, wherein in the second calculation power consumption of the second netlist is determined according to the activity rates of the gated clock buffers, the power consumption attribute parameters of cells to which the output clock of the gated clock buffers is supplied, and a clock frequency and power supply voltage.

7. The LSI power consumption calculation method according to claim 1, wherein
the first and second netlists include: as the cells, a plurality of gated clock buffers which form clock trees and which propagate clock signals in response to enable signals; and registers to which the clock signals of the clock trees are supplied;
the calculating power consumption for the first netlist comprises, on performing logic synthesis of design data described in a hardware description language to generate the first netlist, of extracting, for each of the enable signals, generated gated clock buffers controlled by the enable signal, and generating a first generated gated clock buffer table;
the calculating power consumption for the second netlist further comprises, on performing logic synthesis of design data described in a hardware description language to generate the second netlist, of extracting, for each of the enable signals, generated gated clock buffers controlled by the enable signal, and generating a second generated gated clock buffer table; and
in detecting the correspondence relation, gated clock buffers included in the first and second generated gated clock buffer tables are associated based on the enable signals.

8. The LSI power consumption calculation method according to claim 7, wherein in detecting the correspondence relation, correspondences are detected between generated gated clock buffers with the same enable signal in the first and second netlists.

9. The LSI power consumption calculation method according to claim 7, wherein in the second calculation the power consumption of the second netlist is determined according to the activity rates of the gated clock buffers, the power consumption attribute parameters for cells to which the output clock of the gated clock buffers is supplied, and a clock frequency and power supply voltage.

10. An LSI power consumption calculation program, which calculates power consumption of LSI,
the program causing a computer to execute:
executing logic simulation for a first netlist and determining activity rates for the cells, and calculating power consumption for the first netlist from the activity rates and from power consumption attribute parameters for the cells; and
calculating power consumption for a second netlist having at least a portion of the cells of the first netlist, wherein
the calculating the power consumption of the second netlist comprises:
a correspondence relation detection step of detecting correspondence relations between cells in the first and second netlists;
determining activity rates for each cell of the second netlist from activity rates for the first netlist, based on the cell correspondence relations; and
calculating the second calculation of power consumption from the activity rates for each cell of the second netlist and from power consumption attribute parameters for the cells.

11. The LSI power consumption calculation program according to claim 10, wherein
the first and second netlists include: as the cells, a plurality of gated clock buffers which form clock trees and which propagate clock signals in response to enable signals; and registers to which the clock signals of the clock trees are supplied, and wherein
in detecting the correspondence relation, lower-level gated clock buffers coupled to a register with the same name in the first and second netlists are detected, the upper-level gated clock buffers to which the detected lower-level gated clock buffers are coupled in the first and second netlists are detected, and detection of upper-level gated clock buffers is repeated, to extract correspondence relations between detected gated clock buffers on each level.

12. The LSI power consumption calculation program according to claim 10, wherein
the first and second netlists include: as the cells, a plurality of gated clock buffers which form clock trees, and which propagate clock signals in response to enable signals; and registers to which the clock signals of the clock trees are supplied;
the calculating power consumption calculation for the first netlist comprises, on performing logic synthesis of design data described in a hardware description language to generate the first netlist, of extracting, for each of the enable signals, generated gated clock buffers controlled by the enable signal, and generating a first generated gated clock buffer table;
the calculating power consumption for the second netlist further comprises, on performing logic synthesis of design data described in a hardware description language to generate the second netlist, of extracting, for each of the enable signals, generated gated clock buffers controlled by the enable signal, and generating a second generated gated clock buffer table; and
in detecting the correspondence relation, gated clock buffers included in the first and second generated gated clock buffer tables are associated based on the enable signals.
